(19) United States
(12) Patent Application Publication
(10) Pub. No.: US 2016/0161745 A1
(43) Pub. Date: Jun. 9, 2016

(54) WEARABLE OPTICAL SYSTEM CAPABLE OF DISPLAYING DYNAMIC INFORMATION AND IMAGES AND DISPLAY DEVICE THEREOF

(71) Applicant: BION INC., New Taipei City (TW)

(72) Inventors: Shui-Jung CHEN, NEW TAIPEI CITY (TW); Wen-Pin WENG, NEW TAIPEI CITY (TW)

(73) Assignee: BION INC., NEW TAIPEI CITY (TW)

(21) Appl. No.: 14/952,963

(22) Filed: Nov. 26, 2015

(30) Foreign Application Priority Data
Dec. 3, 2014 (TW) 103142044

(51) Int. Cl. G02B 27/01; G02B 27/00

(52) U.S. Cl. CPC G02B 27/0172; G02B 27/0093; G02B 27/0075; G02B 2027/0178; G02B 2027/0194; G02B 2027/0147; G02B 2027/014

(57) ABSTRACT

A wearable optical system capable of displaying dynamic information and images includes a carrier, an information box and a transparent body. The information box is mounted on the carrier and has a wireless sensing unit, a microprocessor and a display unit mounted therein. The transparent body is mounted on the information box and located within a sight range of the wearer, and has a partially-transmitting coated lens mounted on a surface thereof and located on an optical path of the display unit for forming a virtual image on the wearer's retina. A first convex lens is mounted between the partially-transmitting coated lens and the wearer's eyes for adjusting a position of the virtual image formed inside the wearer's eyes.

### BACKGROUND OF THE INVENTION

1. Field of the Invention

The present invention relates to an optical system and a display device thereof, and, more particularly, to a wearable optical system capable of displaying dynamic information and images and a display device thereof.

2. Description of the Related Art

Since the invention of the cathode ray tube (CRT) back in the early 20^{th} century, display devices using different techniques, such as liquid crystal, plasma, holography, projection and light-emitting diode (LED), have been introduced into the market one after another to meet diversified demands of markets and consumers with their own unique strength in display.

To keep abreast of development of mobile technology, besides smart phones, more and more wearable devices with versatile techniques and functions have been brought into play to perform remote control using wireless signals, such as audio waves and electromagnetic waves, to interact with other equipment or cloud devices through wireless networks to easily display everyday life information, such as date and time, weather, schedules, electronic maps and the like, for users' references, and to take pictures. The Google Project Glass®, which is a wearable display device provided by Google® in the market, relies on a micro projector mounted on a top of the glass but not blocking the views in front of the wearer, and projects images through a prism to form a real image on the wearer's retina. Such special design of the prism allows a two-dimensional layer projected from the micro projector to be combined with the views in the real world in generation of a combined effect of virtual images and real images on the retina simultaneously.

However, as the micro projector in the Google Projector Glass® intends to project original images and form real images on the retina of the wearer, the magnification of the original images is limited.

### SUMMARY OF THE INVENTION

An objective of the present invention is to provide a wearable optical system capable of displaying dynamic information and images and a display device of the wearable optical system for generating virtual images generated according to the technique of virtual image display (VID) and reversibility of an optical path and achieving better depth profiling resolution and image magnification.

To achieve the foregoing objective, the display device includes an information box and a transparent body.

The information box has a microprocessor and a display unit.

The microprocessor is mounted inside the information box.

The display unit is mounted inside the information box, is electrically connected to the microprocessor, and emits light to form an optical path.

The transparent body is mounted on the information box, is adapted to be located within a sight range of a user, and has a partially-transmitting coated lens and a first convex lens.

The partially-transmitting coated lens is mounted on a surface of the transparent body and is located on the optical path of the display unit.

The first convex lens is mounted between the partially-transmitting coated lens and the user's eyes.

To achieve the foregoing objective, the wearable optical system capable of displaying dynamic information and images includes a carrier and a display device.

The display device as described earlier is mounted on the carrier.

The display unit, the transparent body and the partially-transmitting coated lens are combined to construct a display device capable of displaying virtual images of dynamic information and images. According to the law of reflection and the reversibility of the optical path, when light emitted from the display unit is projected onto the partially-transmitting coated lens, the wearer can see information and images displayed on the display unit because the wearer can see an erect virtual image in the partially-transmitting coated lens through the use of the first convex lens. The virtual image formed by the partially-transmitting coated lens provides better depth profiling resolution and image magnification in favor of better space utilization for display and better visual recognition or alerting effect.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a wearable optical system capable of displaying dynamic information and images in accordance with the present invention;

FIGS. 2A and 2B are schematic views showing how the wearable optical system in FIG. 1 forms an image;

FIG. 3 is a schematic view showing an optical path of the wearable optical system in FIG. 1;

FIG. 4 is a schematic view showing a second embodiment of a wearable optical system in accordance with the present invention; and

FIG. 5 is a schematic view showing a third embodiment of a wearable optical system in accordance with the present invention

### DETAILED DESCRIPTION OF THE INVENTION

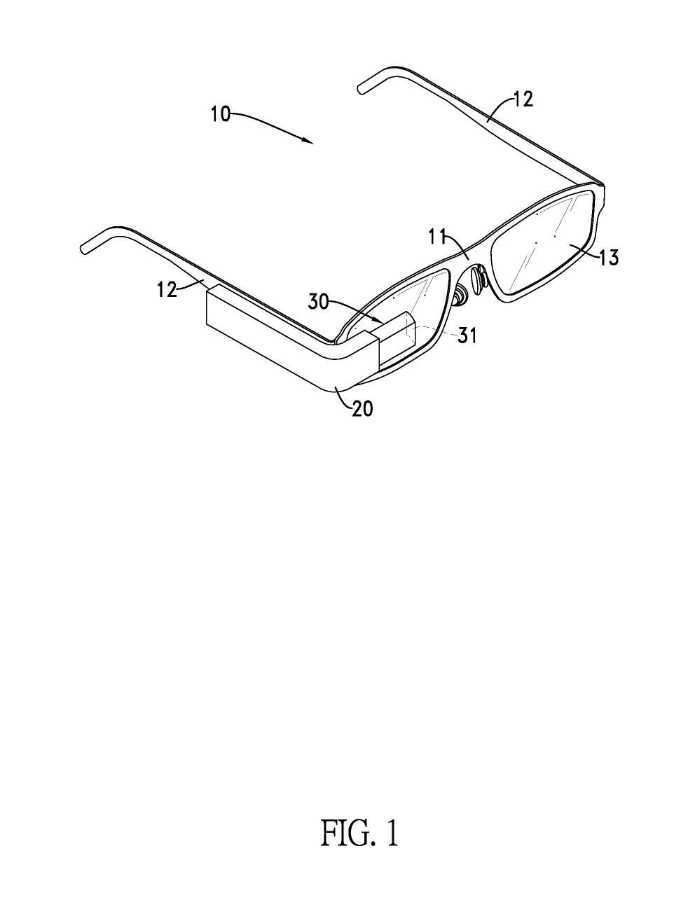

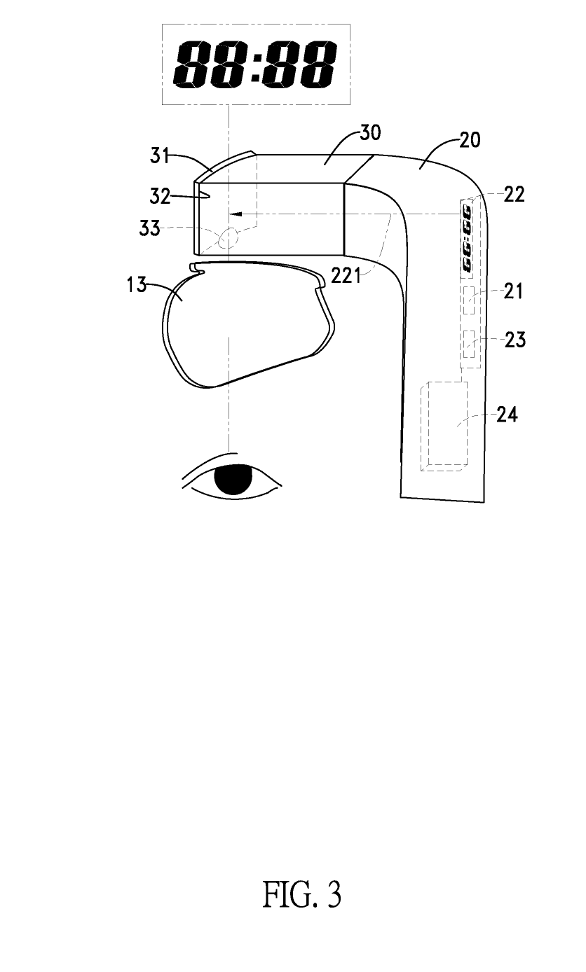

With reference to FIGS. 1 and 3, a first embodiment of a wearable optical system capable of displaying dynamic information and images in accordance with the present invention includes a carrier, an information box 20 and a transparent body 30. In the present embodiment, the carrier is a spectacle 10 having a frame 11 and two temples 12. The information box 20 is mounted on an edge portion of the frame 11 and one of the two temples 12 adjacent to the edge portion of the frame 11. The transparent body 30 is detachably mounted on one end of the information box 20 adjacent to the frame 11 of the spectacle 10 and is located in front of the frame 11 and on a surface within a sight range of the viewer.

The spectacle 10 further has two eyeglass lenses 13. One of the two eyeglass lenses 13 is adjacent to the transparent body 30. The eyeglass lenses 13 may be formed by a transparent material, such as glass, polyethylene terephthalate (PET), acrylic or the like.

The information box 20 serves to process information and output images and includes a microprocessor 21, a display unit 22, a wireless sensing unit 23 and a battery 24 mounted therein. The microprocessor 21 is electrically connected to the display unit 22 and the wireless sensing unit 23 to process and output images and transmit wireless signals. The display unit 22 is arranged to face the transparent body 30 for projecting images along an optical path 221. The wireless sensing unit 23 serves to transmit wireless signals to any electronic device with a communication protocol and a frequency band compatible with those of the wireless sensing unit 23. The electronic device may include one of a GPS (Global Positioning System) device, a distance/speed detection device, a motion/biological detection device, and a climate/environmental detection device, or a combination thereof. The battery 24 is electrically connected to the microprocessor 21, the display unit 22 and the wireless sensing unit 23 to supply power thereto. The wireless sensing unit 23 may include a swimming speed sensor, a bicycle speed sensor, a walking speed sensor and a skiing speed sensor.

In the present embodiment, the transparent body 30 may be formed by a transparent material, such as glass, PET, acrylic or the like. The transparent body 30 has a partially-transmitting coated lens 31 mounted on a surface of the transparent body 30 distal to the information box 20 and located on the optical path 221 of the display unit 22 for light emitted from the display unit 22 to be projected onto the partially-transmitting coated lens 31 in generation of an virtual image viewable to the wearer on the partially transmitting and coated lens 31. The partially-transmitting coated lens 31 may be formed by a transparent material, such as glass, PET, acrylic or the like, and has a first optical film 32 formed on a surface of the partially-transmitting coated lens 31. The first optical film 32 is partially reflective and partially transmitting, may be made of metal with relatively high reflectivity, such as aluminum, chromium, nickel or the like, and may be formed by chemical vapor deposition (CVD) or sputtering process. In the present embodiment, parameters associated with the material and thickness of the first optical film 32 are controlled to affect a ratio between the transmissivity and the reflectivity of the first optical film 32, such that when the partially-transmitting coated lens 31 reflects light emitted from the display unit 22, the wearer can still see the view in front of him/her through the partially-transmitting coated lens 31 without being subject to full or partial view blockage. Furthermore, the first optical film 32 may be prepared in the form of a single layer or multiple layers. In case of multiple layers, optimization of a specific optical band may be achieved by selecting materials for the multiple layers with respective matching optical characteristics and film thicknesses.

With further reference to FIG. 3, a first convex lens 33 is mounted on a light path between the wearer's eyes and the virtual image or between the wearer's eyes and the partially-transmitting coated lens 31 for the optical path 221 of the display unit 22 to pass through the first convex lens 33, and serves to allow a position for formation of the virtual image on the retina of the wearer to be adjusted. Thus, the wearer can see the virtual image clearly.

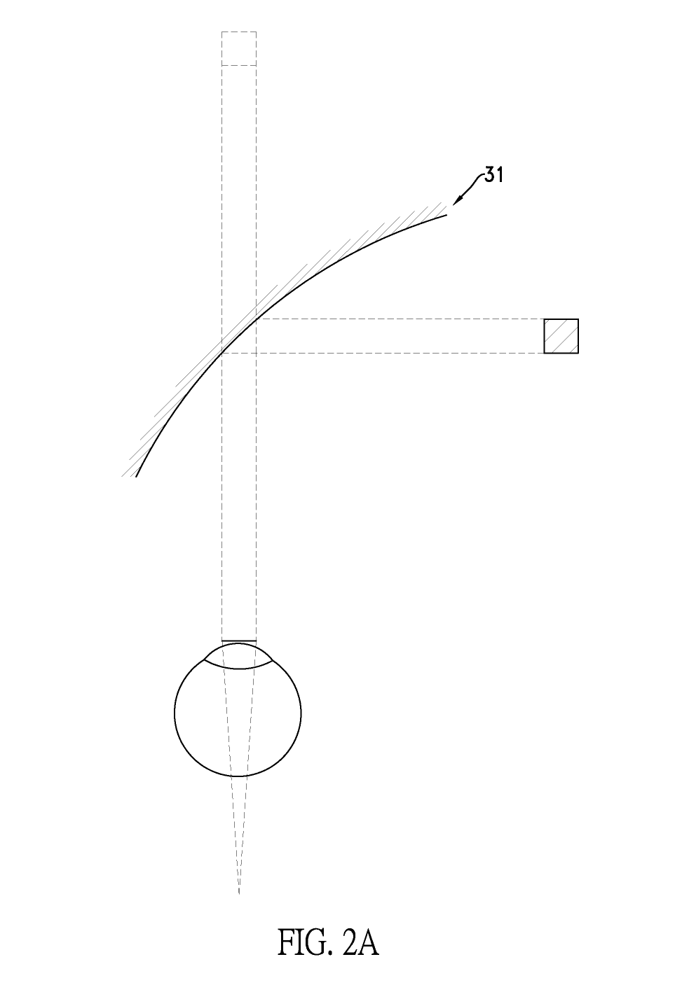

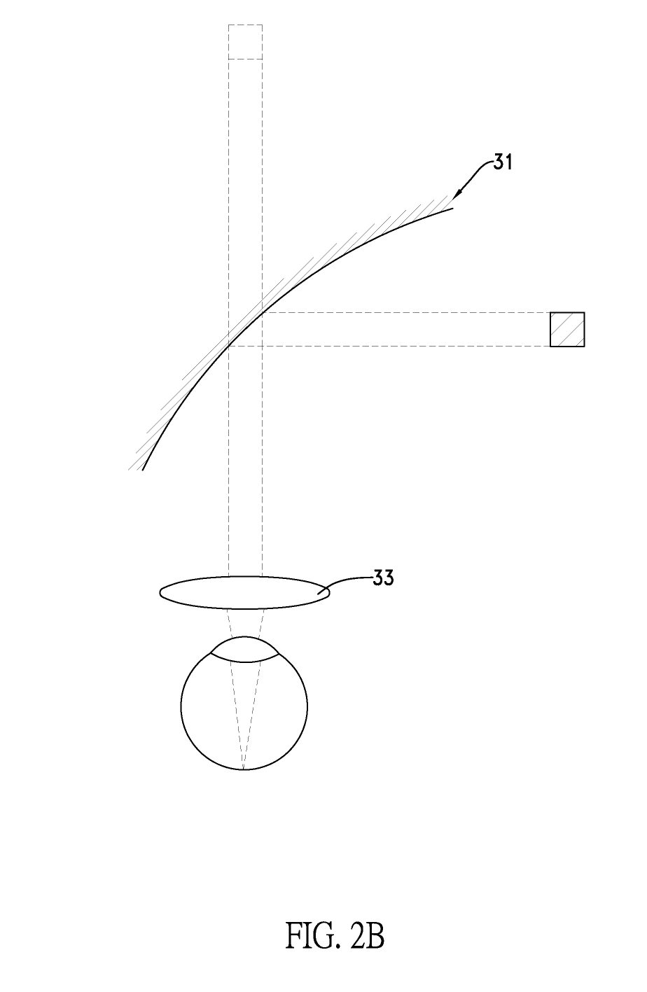

With reference to FIG. 2A, a distance between the position for formation of the virtual image on the wearer's retina and the partially-transmitting coated lens 31 is 5 cm, which can be inferred that a distance between the virtual image in front of the partially-transmitting coated lens 31 and the wearer's eyes is about 10 cm. However, a distance of distinct vision roughly ranges from 15 cm to 35 cm. Under the circumstance, the position for formation of the virtual image in the wearer's eyes is not exactly formed on the wearer's retina and the wearer fails to clearly see the virtual image. A countermeasure for getting a clear virtual image is shown in FIG. 2B. As can be seen from FIG. 2B, an additional convex lens 33 is mounted between the wearer's eyes and the partially-transmitting coated lens 31 and has a focusing effect on light passing through the convex lens 33 and focused by the convex lens 33 to a final position of the virtual image formed in the wearer's eyes. Hence, the virtual image can be formed on the wearer's retina for the wearer to clearly see the virtual image.

With reference to FIG. 3, the optical path 221 of the display unit 22 reaches the first optical film 32 of the partially-transmitting coated lens 31, and an erect virtual image can be generated by the partially-transmitting coated lens 31 according to the light reversibility principle, such that the wearer's eyes can observe the erect virtual image of the partially-transmitting coated lens 31 through the eyeglass lenses 13.

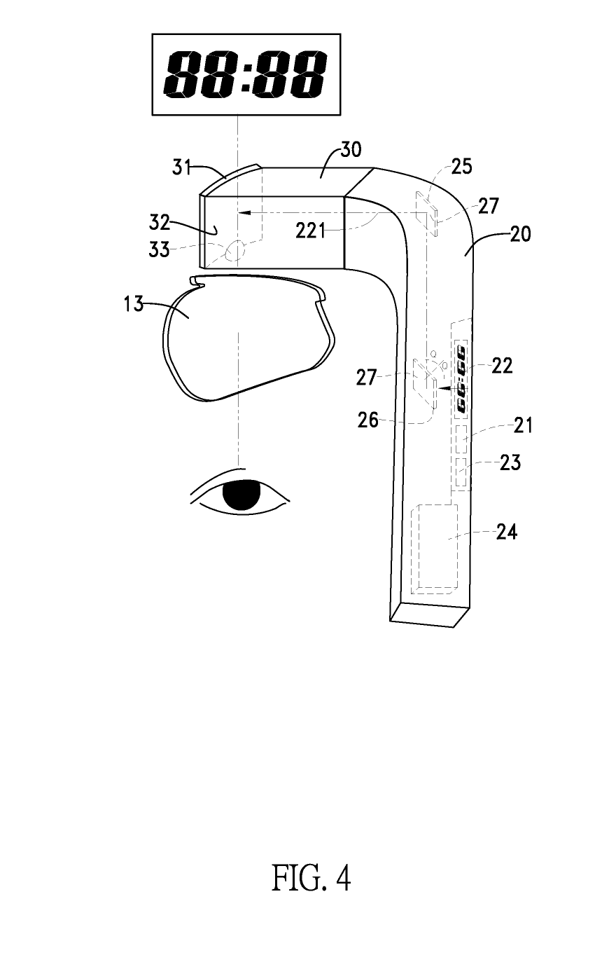

With reference to FIG. 4, a second embodiment of a wearable optical system capable of displaying dynamic information and images in accordance with the present invention differs from the first embodiment in that the information box 20 further includes a first reflective mirror 25 and a second reflective mirror 26 mounted inside the information box 20 and being parallel to each other. The first reflective mirror 25 and the second reflective mirror 26 are located on the optical path 221 of the display unit 22 and serve to extend the optical path 221 of the display unit 22. The first reflective mirror 25 is adjacent to the transparent body 30 and faces the partially-transmitting coated lens 31. The second reflective mirror 26 is adjacent to the display unit 22 and is arranged to be inclined to the display unit 22. Hence, light generated from the display unit 22 is projected onto the partially-transmitting coated lens 31 after being sequentially reflected by the second reflective mirror 26 and the first reflective mirror 25. In the present embodiment, both the first reflective mirror 25 and the second reflective mirror 26 are inclined at an angle of 45 degrees to the display unit 22. Each of the first reflective mirror 25 and the second reflective mirror 26 has a second optical film 27 formed thereon and the two second optical films 27 are respectively formed on two opposite surfaces of the first reflective mirror 25 and the second reflective mirror 26. Same material and thickness can be chosen for the first optical film 32 and the second optical film 27 or the first reflective mirror 25 and the second reflective mirror 26 may be regular reflective mirrors without the optical characteristics of being partially-transmitting and partially reflective.

Given the combination of the display unit 22, the transparent body 30 and the partially-transmitting coated lens 31, a low-cost virtual image display can be constructed. According to the law of reflection and the reversibility of the optical path 221, when light emitted from the display unit 22 is projected onto the partially-transmitting coated lens 31, the wearer can see information and images displayed on the display unit 22 inasmuch as the wearer can see an erect virtual image in the partially-transmitting coated lens 31 through the use of the first convex lens 33. The virtual image formed by the partially-transmitting coated lens 31 provides better depth profiling resolution and image magnification in favor of better space utilization for display and better visual recognition or alerting effect.

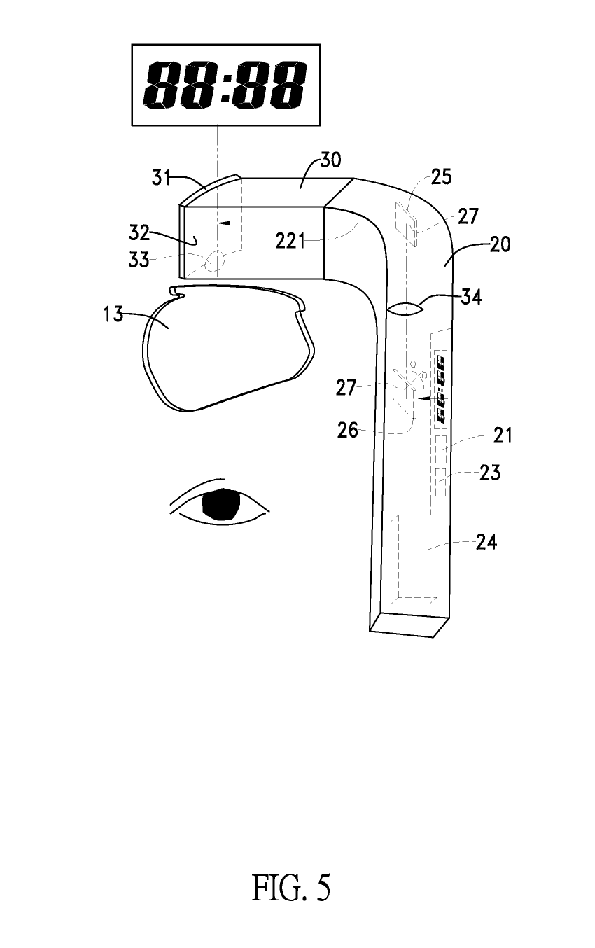

With reference to FIG. 5, a third embodiment of a wearable optical system capable of displaying dynamic information and images in accordance with the present invention differs from the first embodiment in that the information box 20 further includes a second convex lens 34. The second convex lens 34 is mounted on the optical path 221 between the display unit 22 and the partially-transmitting coated lens 31 for light emitted from the display unit 22 to pass through. The second convex lens 34 and the first convex lens 33 are adjusted to improve the image quality of information and images viewed by the wearer.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A display device, comprising:
an information box having:
a microprocessor mounted inside the information box; and
a display unit mounted inside the information box, electrically connected to the microprocessor, and emitting light to form an optical path; and
a transparent body mounted on the information box, adapted to be located within a sight range of a user, and having:
a partially-transmitting coated lens mounted on a surface of the transparent body, and located on the optical path of the display unit; and
a first convex lens mounted between the partially-transmitting coated lens and the user's eyes.

2. The display device as claimed in claim 1, wherein the partially-transmitting coated lens is mounted on the surface of the transparent body distal to the information box, and has a first optical film formed on a surface of the partially-transmitting coated lens.

3. The display device as claimed in claim 2, wherein the information box further has:
a first reflective mirror mounted inside the information box, located on the optical path of the display unit, adjacent to the transparent body, and facing the partially-transmitting coated lens; and
a second reflective mirror mounted inside the information box, parallel to the first reflective mirror, located on the optical path of the display unit, adjacent to the display unit, and arranged to be inclined to the display unit;
wherein light generated from the display unit is projected onto the partially-transmitting coated lens after being sequentially reflected by the second reflective mirror and the first reflective mirror, each of the first reflective mirror and the second reflective mirror has a second optical film, and the two second optical films are respectively formed on two opposite surfaces of the first reflective mirror and the second reflective mirror.

4. The display device as claimed in claim 1, wherein the information box further has a second convex lens mounted on the optical path and located between the partially-transmitting coated lens and the display unit.

5. The display device as claimed in claim 1, wherein the information box further has a wireless sensing unit electrically connected to the microprocessor.

6. The display device as claimed in claim 4, wherein the information box further has a wireless sensing unit electrically connected to the microprocessor.

7. The display device as claimed in claim 5, wherein the information box further has a battery electrically connected to the microprocessor, the display unit and the wireless sensing unit.

8. The display device as claimed in claim 6, wherein the information box further has a battery electrically connected to the microprocessor, the display unit and the wireless sensing unit.

9. A wearable optical system capable of displaying dynamic information and images, comprising:
a carrier; and
a display device mounted on the carrier and having:
an information box having:
a microprocessor mounted inside the information box; and
a display unit mounted inside the information box, electrically connected to the microprocessor, and emitting light to form an optical path; and
a transparent body mounted on the information box, adapted to be located within a sight range of a user, and having:
a partially-transmitting coated lens mounted on a surface of the transparent body and located on the optical path of the display unit; and
a first convex lens mounted between the partially-transmitting coated lens and the user's eyes

10. The wearable optical system as claimed in claim 9, wherein the carrier is a spectacle having a frame and two temples.

11. The wearable optical system as claimed in claim 10, wherein the frame of the carrier has two eyeglass lenses adjacent to the transparent body.

12. The wearable optical system as claimed in claim 11, wherein the information box of the display device further has a wireless sensing unit including a swimming speed sensor, a bicycle speed sensor, a walking speed sensor and a skiing speed sensor.
